(19) United States
(12) Patent Application Publication
(10) Pub. No.: US 2007/0252660 A1
(43) Pub. Date: Nov. 1, 2007

(54) Single-substrate planar directional bridge

(76) Inventors: Uriel C. Fojas, Santa Rosa, CA (US); Curtis R. Kimble, Cotati, CA (US)

Correspondence Address: AGILENT TECHNOLOGIES INC., INTELLECTUAL PROPERTY ADMINISTRATION,LEGAL DEPT., MS BLDG. E P.O. BOX 7599, LOVELAND, CO, 80537, US

(21) Appl. No.: 11/414,493

(22) Filed: Apr. 28, 2006

(51) Int. Cl. H01P 5/18

(52) U.S. Cl. 333/116

(57) ABSTRACT

A directional bridge circuit is formed on a single substrate. The substrate has an access hole and is housed in a conductive package. A pedestal extends from the conductive package and enables a physical connection between the directional bridge circuit and the pedestal through the access hole.

### BACKGROUND OF THE INVENTION

Couplers play an important role in network measurement systems. In addition to providing connections between a network measurement system and a device under test (DUT), couplers provide the function of separating incident and reflected waves for network measurements. One known type of coupler, shown as a circuit schematic in FIG. 2, is a directional bridge. The directional bridge is commonly used in network measurement systems, such as scalar and vector network analyzers.

Previous designs for the directional bridge required two substrates to accommodate the entire circuit. Typically, one substrate would be stacked on top of the other. However, this arrangement results in undesirable signal coupling between the two substrates. Furthermore, it is difficult to align the substrates to each other during assembly. Also, due to the stacked nature of the substrates, it is impossible to visually inspect the lower substrate for problems once the directional bridge is fully assembled.

Therefore, there exists a need for a directional bridge formed on a single substrate.

### BRIEF DESCRIPTION OF THE DRAWINGS

FIGS. 1A-1C show a directional bridge made according to the present invention. FIG. 1A is a top view, FIG. 1B is close-up of the top view in FIG. 1A, and FIG. 1C is a cross-sectional view of the directional bridge taken through the line C-C′ in FIG. 1A.

FIG. 2 shows a schematic diagram of a directional bridge circuit.

FIGS. 3A-3B show a prior art directional bridge. FIG. 3A is a top view of the prior art directional bridge, and FIG. 3B is a cross-sectional view taken through the line B-B′ in FIG. 3A.

FIG. 4 is a performance plot comparing the directivity of the prior art two-substrate directional bridge with the single-substrate directional bridge.

FIG. 5 is a plot comparing the test port match of the prior art directional bridge with the single-substrate directional bridge.

### DETAILED DESCRIPTION

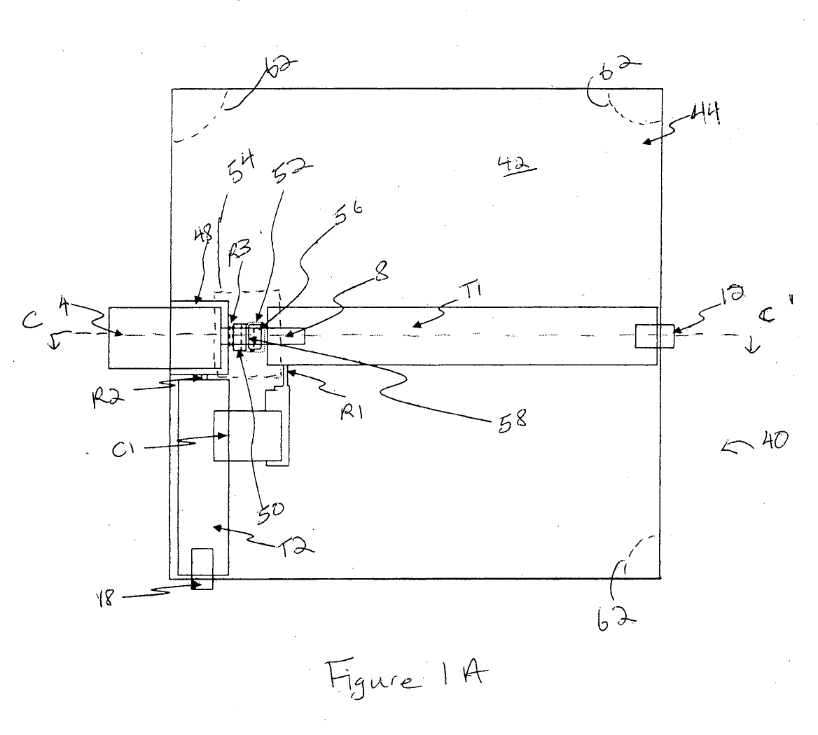

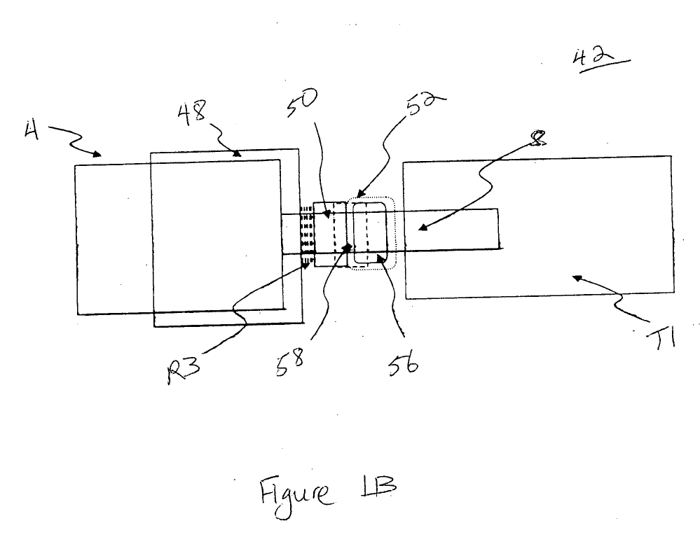

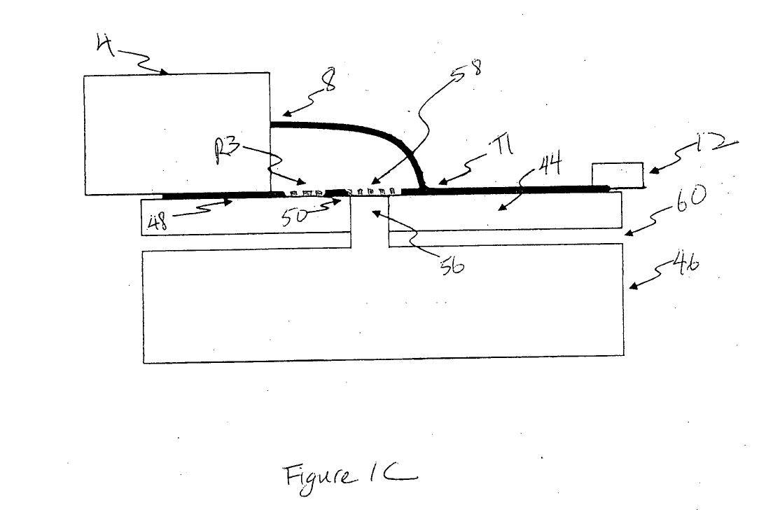

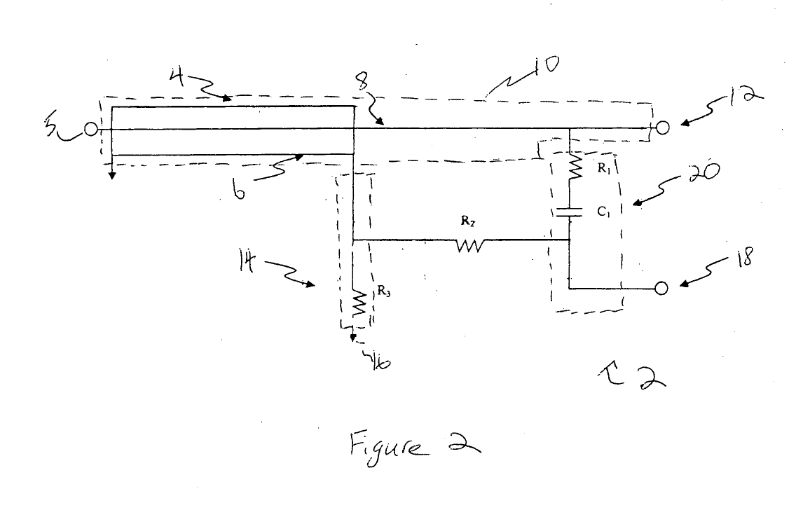

FIGS. 1A-1C show one embodiment of a directional bridge 40 made according to the present invention, based on a schematic diagram shown in FIG. 2. The directional bridge circuit 2 shown in FIG. 2 has a balun 4 having an outer conductor 6 and a center conductor 8 which is located at the input 5 of a main line 10 of the directional bridge 2. The center conductor 8 is coupled to a test port 12. The outer conductor 6 is coupled to a ground shunt 14, which includes a resistor R3 that is coupled to a ground 16. The test port 12 is coupled to a coupled port 18 by a coupling shunt 20, which includes a resistor R1 and a capacitor C1 in series. The ground shunt is coupled to the coupling shunt by a resistor R2 as shown in FIG. 1. Typically, a network analyzer is connected to the balun and the DUT is connected at the test port.

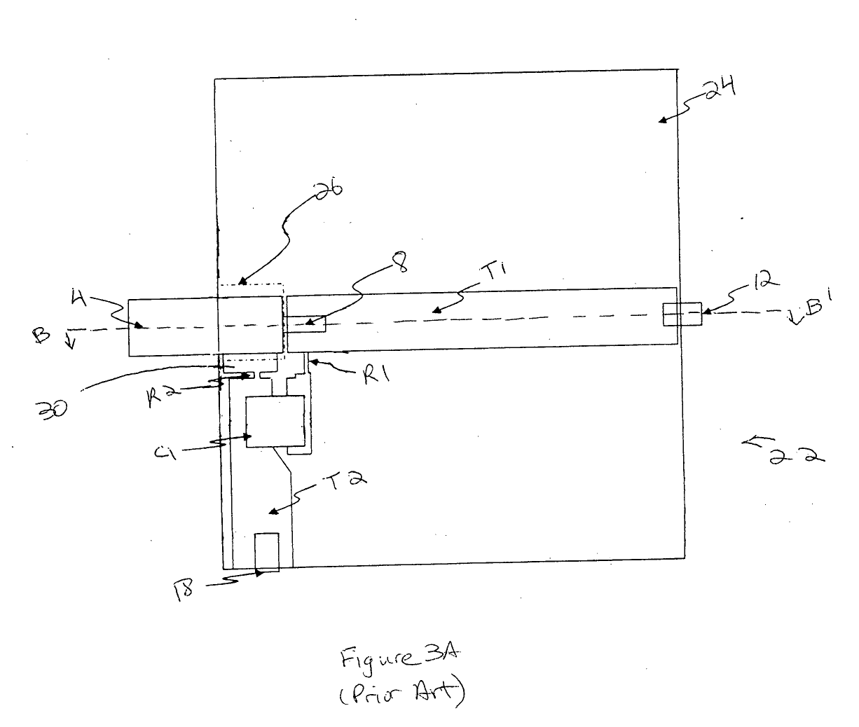

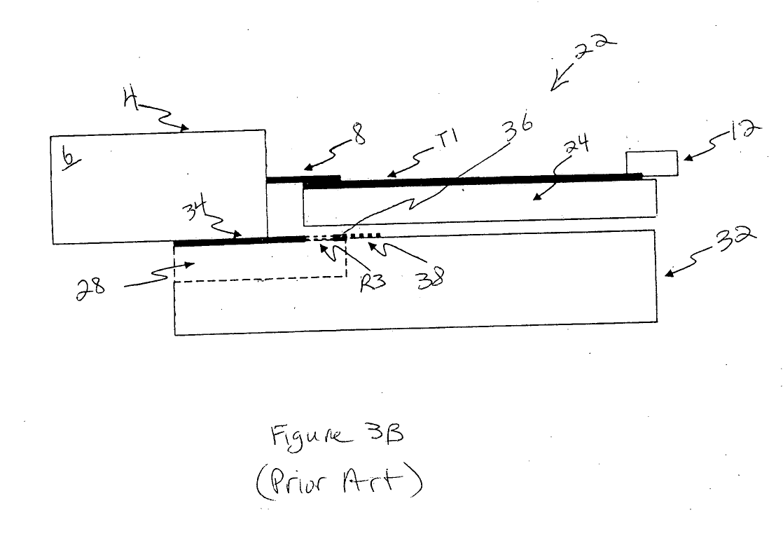

In the past, two substrates were needed to implement the directional bridge circuit 2. FIG. 3A is a top view of a prior art directional bridge 22, which is one implementation of the directional bridge circuit 2 shown in FIG. 2. Directional bridge 22 was previously disclosed in U.S. patent application Ser. No. 10/882,017, “Directional Bridge Coupler”, assigned to Agilent Technologies, Inc. in Palo Alto, Calif., USA. A top substrate 24 has a cutout 26 to accommodate a balun 4 resting on a lower substrate 28, (not visible in FIG. 3A). The center conductor 8 of the balun 4 is connected to a first transmission line T1, which leads to the test port 12. The resistor R1 and capacitor C1 are formed in series between transmission lines T1 and a second transmission line T2 that leads to the coupled port 18. The resistor R2 is formed between the transmission line T2 and a contact pad 30 that leads to the balun 4. A gold ribbon (not shown) is attached to the contact pad 30 and then attached to the balun outer conductor 6 with conductive epoxy. Resistors R1, R2, and R3 are tantalum nitride (TaN) thin-film resistors, while C1 is a separate, discrete chip package. T1 and T2 are formed by plating gold metal onto the substrate. Resistor R1 is 265 Ohms, resistor R2 is 50 Ohms, resistor R3 is 10 Ohms, and capacitor C1 is 8200 picoFarads.

FIG. 3B is a cross-sectional view of the prior art directional bridge 22, taken through the line B-B′ in FIG. 3A. The lower substrate 28 is housed in a conductive package 32 which functions as ground 16. The outer conductor 6 of the balun 4 is joined to a contact pad 34 on the lower substrate 28 with conductive epoxy. The resistor R3 is connected to a grounding pad 36, both of which are also formed on the lower substrate. A conductive interconnect 38 (typically gold ribbon or mesh) joins the grounding pad 36 to the conductive package 32. When the directional bridge 22 is fully assembled, the resistor R3, the grounding pad 36, and the gold ribbon 38 all lie under the top substrate 24.

Previously, two substrates were necessary to implement the directional bridge circuit 2 due to a mistaken belief that the directional bridge circuit's connection to ground 16 had to be aligned under the balun center conductor 8 where it overlapped with transmission line T1. Furthermore, the common perception was that the ground shunt 14 and the center conductor 8 needed to be as short as possible to minimize inductance in those paths for the purpose of keeping the directional bridge 22 balanced.

FIG. 1A shows a top view of one embodiment of a directional bridge 40 made according to the present invention. FIG. 1B shows a close-up, top view of the region 54 in the directional bridge 40. The entire directional bridge 40 is formed on a surface 42 of a single substrate 44. The substrate 44 is typically made of a ceramic, such as alumina, although it can also be fabricated from other materials such as fused silica and beryllia. The substrate 44 is housed and supported by a conductive package 46 (not seen in this top figure). A balun 4 rests on a contact pad 48 on the substrate surface 42. The resistor R3 (with a value of 10 Ohms) is coupled to the contact pad 48. A grounding pad 50 is coupled to the resistor R3.

An access hole 52 is positioned near the grounding pad 50. A pedestal 56 extends from the conductive package 46 and has a bonding surface that is at substantially the same planar level as the substrate surface 42, so that a conductive interconnect 58 (typically gold ribbon or mesh) can be attached between the grounding pad 50 and the bonding surface of the pedestal 56. The transmission line T1 is formed proximate to the access hole 52 and leads to the test port 12. The center conductor 8 of the balun 4 is connected to the transmission line T1. The remaining components R1, R2, C1, and T2 are formed in the same manner as before, with no change in values.

FIG. 1C is a cross-sectional view of the directional bridge 40 taken through the line C-C′ in FIG. 1A. The center conductor 8 of the balun 4 arcs over the resistor R3, the grounding pad 50, and the access hole 52 (not visible in this view), to reach the transmission line T1. The pedestal 56 extends from the conductive package 46, which typically functions as ground. Ideally, the pedestal 56 and the conductive package 46 should be one integral part. However, if some degradation in performance can be tolerated, the pedestal 56 could also be a separate component that is attached to the conductive package 46.

The pedestal 56 does add some length and inductance to the ground shunt 14 from the balun outer conductor 6 to RF ground 16. However, the directional bridge 40 remains balanced due to the additional length and inductance that is added to the center conductor 8 of the balun 4, since it now has to cross over the additional length introduced by having the resistor R3, the grounding pad 50, and the access hole 52 to reach the transmission line T1.

The surface area of the pedestal 56 should be kept reasonably small to limit the inductance in series with the transmission line T1, since a larger pedestal surface area corresponds to a longer center conductor 8 which is inductive at RF/microwave frequencies. However, the surface area must be large enough to accommodate a bond with the conductive interconnect 58. Therefore, the surface area of the pedestal will depend on the dimensions of the bonder used to bond the conductive interconnect 58. The access hole 52 must be large enough to accommodate the pedestal 56 with some mechanical tolerance. In the examples shown, the access hole 52 has dimensions of 0.5 millimeters (mm) by 1.2 mm. The pedestal 56 has a bonding surface that is 0.35 mm by 0.6 mm, and a height of 0.458 mm. The height of the pedestal should also be kept as reasonably short as possible, to limit the inductance and electrical delay in the ground shunt 14.

The resistor R3 can be formed elsewhere on the substrate 44, but a primary concern is to keep the ground shunt 14 as reasonably short as possible so as not to add excessive inductance and electrical delay. Furthermore, any changes to the length of ground shunt 14 should be matched with corresponding changes to the length of the balun center conductor 8 or other types of capacitive or inductive RF/microwave compensation techniques so as to keep the directional bridge 40 balanced.

An optional air gap 60 between the substrate 44 and the conductive package 46 is visible in FIG. 1C. The air gap 60 is created by supporting the substrate 44 at its outer edges as indicated by dashed lines 62 in FIG. 1A. The air gap 60 increases the inductance between the transmission lines (T1 and T2) and the conductive package 46, which allows the width of transmission lines T1 and T2 to be made wider to achieve a 50 Ohm impedance. Wider trace widths result in smaller impedance variation given a fixed trace width manufacturing accuracy. If the substrate 44 rested directly on the conductive package 46, the transmission lines would have to be manufactured to stricter tolerances or a larger impedance variation should be expected.

As mentioned previously, the directional bridge provides an important function of separating incident and reflected waves for network measurements. The measure of this separation between incident and reflected waves, referred to as directivity, influences the measurement accuracy of the network measurement system. Higher directivity generally increases measurement accuracy. The prior art directional bridge 22 had acceptable directivity with an operating range of up to 9 GigaHertz (GHz).

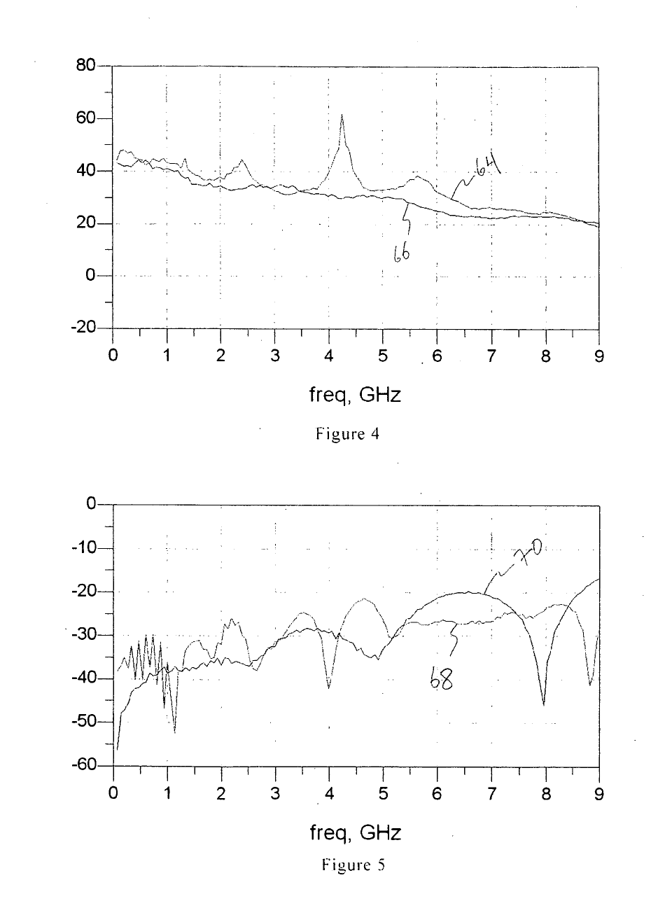

FIG. 4 is a performance plot of directivity (in dB) versus frequency, comparing the directivity of the prior art two-substrate directional bridge 22 (line 64) with the single-substrate directional bridge 40 (line 66). As seen in the plot, the directivity for the single-substrate directional bridge 40 remains above 20 dB up to 9 GHz and is comparable in performance to the prior art two-substrate directional bridge.

FIG. 5 is a plot of the test port match (in dB) versus frequency, comparing the test port match of the prior art directional bridge 22 (line 68) with the single-substrate directional bridge 40 (line 70). The single-substrate directional bridge 40 has a longer center conductor 8 than the two-substrate directional bridge 22 since it has to arch over the resistor R3 and the access hole 52 to reach the transmission line T1. However, as shown in FIG. 5, the test port match of the single substrate directional bridge 40 is comparable to that of the prior art directional bridge 22.

Therefore, the single-substrate directional bridge 40 is capable of matching the performance of the prior art two-substrate directional bridge 22, without any of the alignment issues and undesirable signal coupling that was problematic in the prior art. Furthermore, with the directional bridge circuit formed on a single substrate, a visual inspection can be made of the entire circuit after assembly.

What is claimed is:

1. An apparatus, comprising:
a substrate having an access hole;
a directional bridge circuit formed on the substrate;
a conductive package housing the substrate; and
a pedestal extending from the conductive package, enabling a physical connection between the directional bridge circuit and the pedestal through the access hole.

2. An apparatus as in claim 1, wherein the pedestal is integral to the conductive package.

3. An apparatus as in claim 2, wherein the physical connection connects a ground shunt of the directional bridge circuit to the pedestal.

4. An apparatus as in claim 3, wherein the directional bridge circuit further comprises:
a main line coupling an input port to a test port;
a coupling shunt coupling the test port to the coupled port; and
a ground shunt coupling the input port to the pedestal.

5. An apparatus as in claim 4, wherein
the main line includes a balun having a center conductor and an outer conductor, the center conductor being coupled to a first transmission line formed on a surface of the substrate, and
the ground shunt includes an impedance coupled between the outer conductor and the pedestal that is formed on the same surface as the first transmission line.

6. An apparatus as in claim 5, wherein the impedance includes a thin-film resistor formed on the surface of the substrate between the balun and the access hole.

7. An apparatus as in claim 6, wherein the center conductor passes over the thin-film resistor and the access hole before connecting to the first transmission line.

8. An apparatus as in claim 1, wherein the pedestal is separately attached to the conductive package.

9. An apparatus as in claim 1, wherein the substrate is ceramic.

10. An apparatus as in claim 1, wherein the directivity of the directional bridge circuit is greater than 20 dB at a frequency of 9 GigaHertz.
